(19) United States
(12) Patent Application Publication
(10) Pub. No.: US 2011/0004684 A1
(43) Pub. Date: Jan. 6, 2011

(54) Prediction Of Systems Location Inside A Data Center By Using Correlation Coefficients

(76) Inventor: Wilfredo E. Lugo, Rincon, PR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/919,153

(22) PCT Filed: Mar. 6, 2008
(86) PCT No.: PCT/US08/02982

§ 371 Date: Aug. 24, 2010

(51) Int. Cl. G06F 15/173

(52) U.S. Cl. 709/224

(57) ABSTRACT

The present invention enables location prediction of a system in a data center. Specifically, the invention monitors resources from the systems in the data center and measuring points in the data center. A system resource monitors the internal conditions of the system. A data center measuring point is any device which provide environment or data center resource information of the data center. The conditions obtained from the system resources and measuring points are correlated, and then utilized to predict the location of the system in the data center. For example, by correlating heat sensor values and bandwidth measurements, the prediction mechanism may be able to predict that a system that has a spike in network usage and is at fully capacity is near measuring points that detected an increased heat sensor value and detected increased bandwidth usage at the same time that the machine had its spike in network usage.

### BACKGROUND OF THE INVENTION

Data center density has been increasing over the past few years. Consolidating data involves optimizing the data center resources while potentially reducing the total cost of ownership of the systems inside the data center. These trends are causing the deployment of very large data centers (for example, data centers with an area of 80,000 to 110,000 square feet) with 1000s or 10,000s systems located inside the data center.

The large number of systems in a data center is also due to the changing storage solutions of those systems. Currently, one rack can hold hundreds of systems. This is in contrast to a few years ago, when one rack would hold one system and its storage. With the onset of these very large data centers that hold an unprecedented number of systems, specific issues arise. Locating the systems in the data center is an issue that arises with the changing model of current data centers.

One prior art solution to locating a system within a data center utilizes an external database that details the location of the systems in the data center. In this situation, an external tool or database is updated periodically by a Data Center operator. If the system hostname is changed, or if the system has another LAN card with another IP address, then the database needs to be manually updated. Maintenance costs with this solution are high, and further, there is no guarantee that the database is always up-to-date because it relies on human maintenance.

Another prior art solution involves placing human-readable labels on each system in a data center. However, in a data center with hundreds, thousands, or even tens of thousands of machines, utilizing the labels on a machine to determine the location of a specific machine or group of machines is extremely inefficient. This would involve a Data Center operator walking through the aisles of racks in the data center, reading labels to locate the machine. Further, if the machine were moved, a new label would need to be manufactured and placed on the machine by a Data Center operator. This approach is not scalable to current large data centers. Walking through a data center with thousands of racks and thousands or tens of thousands of systems to locate a specific system is impractical and inefficient.

A further prior art solution modifies the hostnames of the machines in a data center to include the location of that machine in the data center. An example of such a hostname would be rack31-blade3.hp.com. Thus, a data center operator only needs to look at the hostname to locate the rack on which the system is placed. However, if the system is moved to another rack, or a new system is installed on the same location, utilizing a hostname in this fashion could become burdensome. However, if the location of the machine changes, external forces are necessary to update the hostname of the machine to reflect the location change. Further, resident software on those systems could be hostname sensitive, and it may have problems with hostname changes. Server licensing mechanisms, for example, often has issues with hostname changes.

Currently, determining the location of a system in a data center is a static process. Further, each of these prior art solutions requires human intervention for maintenance. These prior art solutions pose problems in maintaining accurate locations for the systems in a data center. Often, knowledge of the location of systems that support specific applications are known only by those persons who work on those applications. If those persons are no longer involved with the operation of the data center, or an emergency occurs, that knowledge may not necessarily be propagated to everyone.

Another prior art solution utilizes RFID tags, that are placed on each system in the data center. However, this solution is very expensive to implement and requires a lot of investment. Each system has to be retro-fitted for the solution to work. Thus, it may not be the most conducive solution in terms of time and cost.

Thus, there is a need in the art for a location prediction system that automatically predicts and updates the locations of systems in a data center without the need for extensive infrastructure change in the data center or large initial implementation costs.

### SUMMARY OF THE INVENTION

One embodiment of the invention relates to an apparatus for predicting a location of a system in a data center, comprising a resource monitor for obtaining values from a resource in a data center, a system monitor for obtaining values from a resource of the system, a correlation component for correlating the values from the resource monitor with the values from the system monitor, and a prediction component for predicting the location of the system in the data center based upon the correlation.

Another embodiment of the invention relates to a method to predict a location of a system in a data center, comprising monitoring at least one measuring point in the data center, monitoring at least one resource of the system, correlating the values of the measuring points with the system resources, and predicting the location of the system in the data center based upon the correlation.

A third embodiment of the invention relates to a computer readable medium, having installed thereon computer readable code which when executed, performs a method to predict a location of a system in a data center, comprising monitoring at least one measuring point in the data center, monitoring at least one resource in the data center, monitoring at least one resource of the system, correlating the values of the measuring points with the system resources, and predicting the location of the system in the data center based upon the correlation.

Another embodiment of the invention relates to an apparatus for predicting a location of a system in a data center, comprising means for obtaining values from a resource in a data center, means for obtaining values from a resource of the system means for correlating the values from the resource monitor with the values from the system monitor, and means for predicting the location of the system in the data center based upon the correlation.

### BRIEF DESCRIPTION OF THE DRAWINGS

FIG. 1 is a schematic diagram of an exemplary data center.

FIG. 2 is a flowchart for one embodiment of the invention.

FIG. 3 is a schematic diagram of another embodiment of the invention.

FIG. 4 is an schematic diagram of a rack in a data center.

FIG. 5 is a graphical depiction of the results of the correlation for an exemplary location prediction.

FIG. 6 is a chart depicting correlation results.

FIG. 7 is a chart depicting correlation results.

### DETAILED DESCRIPTION OF THE PREFERRED EMBODIMENTS

Embodiments of the present invention will now be explained below with reference to the drawings.

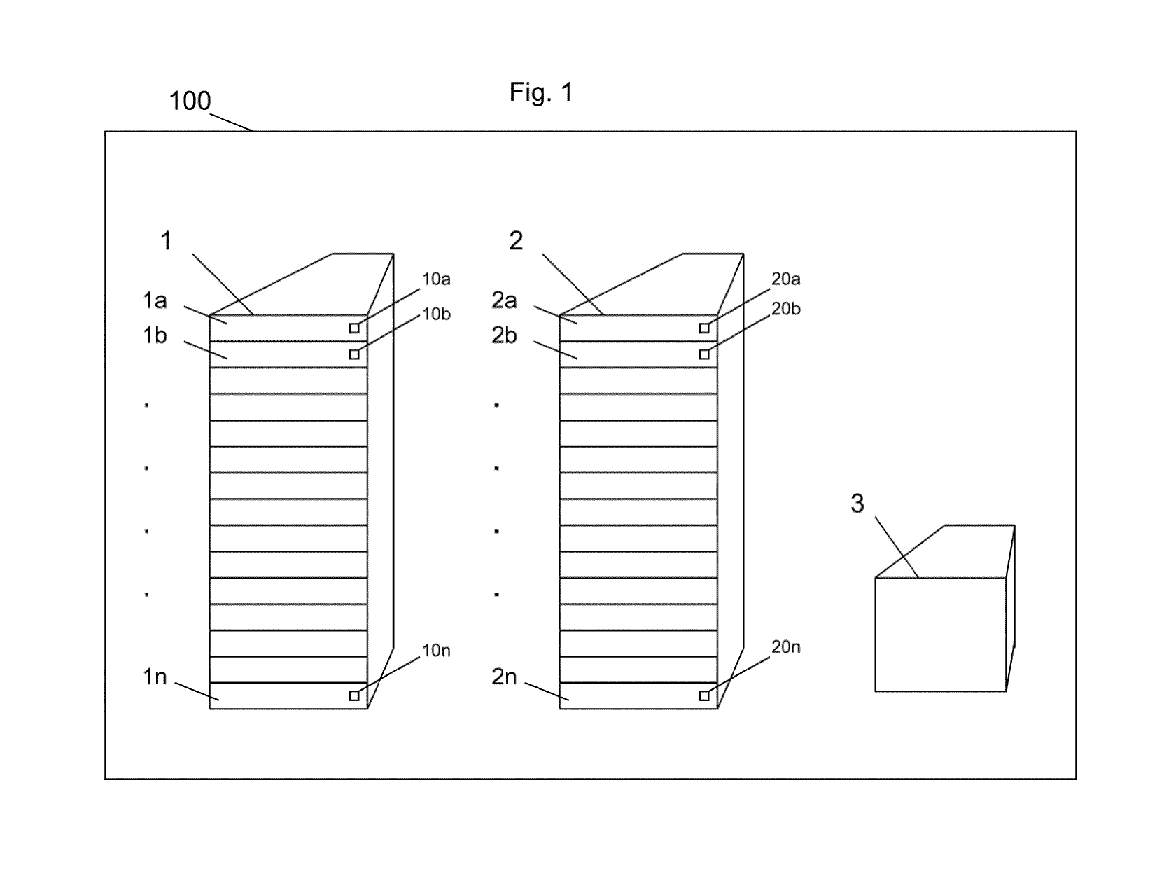

FIG. 1 is a depiction of an exemplary data center. As shown in FIG. 1, there are one or more racks of servers (1, 2, etc.) that contain one or more servers (1a, 1b . . . 1n) (2a, 2b, . . . , 2n). Each of these servers contains one or more sensors (10a, 10b, . . . , 10n) (20a, 20b, . . . , 20n) that monitor the conditions around them. In one embodiment, sensors are located on both the front and back of the racks. The sensors located on the back of the racks are not depicted. Although the number of sensors are shown in a one-to-one relationship with the number of servers, this is not necessary in the data center or for the invention.

These sensors are contained on the servers or are positioned near a server or group of servers on the server rack. For example, sensor 10a may monitor conditions for only server 1a, or may monitor conditions for a group of servers, such as servers 1a, 1b and 1c. A plurality of sensors may be positioned on the server racks, either on or near the servers. Of those sensors potentially positioned on the server racks, the sensors may be placed on each panel of the rack, or on each rack. These sensors can monitor a plurality of conditions. For example, a non-limiting list of conditions they could potentially monitor would include heat, power, bandwidth usage, humidity, to name a few.

These sensors are an example of data center measuring points. Another example of a data center measuring point is depicted in FIG. 1 by exemplary data center measuring point 3. A data center measuring point is any device which provides environment or data center resource information of the data center. Examples of data center measuring points include air conditioners, thermal sensors, power meters, network bandwidth usage measurers, humidity sensors, and so forth. These measuring points may be located on a system, on a server rack, in a data center resource, near a data center resource, or in any other location in the data center. The location of each measuring point in the data center is known. The list of exemplary measuring points is not exhaustive; rather, data center measuring points can comprise any device contained in a data center that provides environment or data center resource information.

A data center needs certain inputs in order to operate properly. The basic inputs for any data center are power, a proper environment, and network bandwidth. This list of exemplary inputs is in no way limiting, but rather constitutes some of the inputs that are utilized in the operation of the data center. As mentioned above, the data center contains resources that provide the inputs into the data center. These resources are monitored and measured to ensure that the conditions in the data center are optimal for operation. Measuring points provide information regarding the conditions of the data center, with regards to its resources and environment of the data center.

Each system in the data center uses similar inputs that are essential to operate the system. These inputs are similar to those utilized for the data center. For example, inputs to a system include, but are not limited to, power, a proper environment, and network bandwidth. Each system monitors its internal system conditions. For example, systems contain resources such as sensors or other monitors to monitor internal system temperature, utilization, fan speeds, and other system conditions. The system's internal utilization, for one embodiment, has a strong correlation with heat dissipation and power consumption in the system. This is evident in a system that does a lot of work, as the system's temperature rises faster, power consumption increases, and fan speed increases to prevent overheating of the system. The system resource are measured and monitored to ensure optimal operation and understanding of the system.

A system in the data center can be any type of equipment that has an ability to connect to a network, and that is able to provide information about its resource consumption and/or its environment (i.e. information about power, network, temperature, and so forth). Examples of systems include servers or computer systems in the data center, storage, media libraries, and network infrastructure, to name a few. The type of systems utilized in location prediction are not limiting on the invention.

Because we can correlate the utilization and workload of a system to conditions of its system resources, we can utilize that correlation to potentially identify a specific system by the conditions of the system resources. Thus, we can make a further correlation of corresponding measured conditions from system resources with measured conditions from measuring points in the data center to predict the location of systems in the data center.

The present invention can also utilize a lagged correlation to correlate the measured conditions of system resources with measured conditions from measuring points in the data center. There are some resources, in both the data center and within the system, that are not immediately affected by changes in other resources. This lag in effect may be a result of requiring some time for the resource to change in response to changes they detect. For example, increasing the power given to an air conditioner, that emits colder air, may not have an immediate effect on a computer system positioned close to it in the data center. Rather, it will take some time for the air to cool to have an effect on the system. This lag time may be even higher for a system further away from the air conditioner in the data center. Thus, using a lagged correlation may provide more accurate results as to how resources in the data center and within the systems of the data center affect one another. The present invention is able to utilize an immediate correlation, a lagged correlation, or a combination of both types of correlation. The type of correlation utilized in the system is not limiting on the invention.

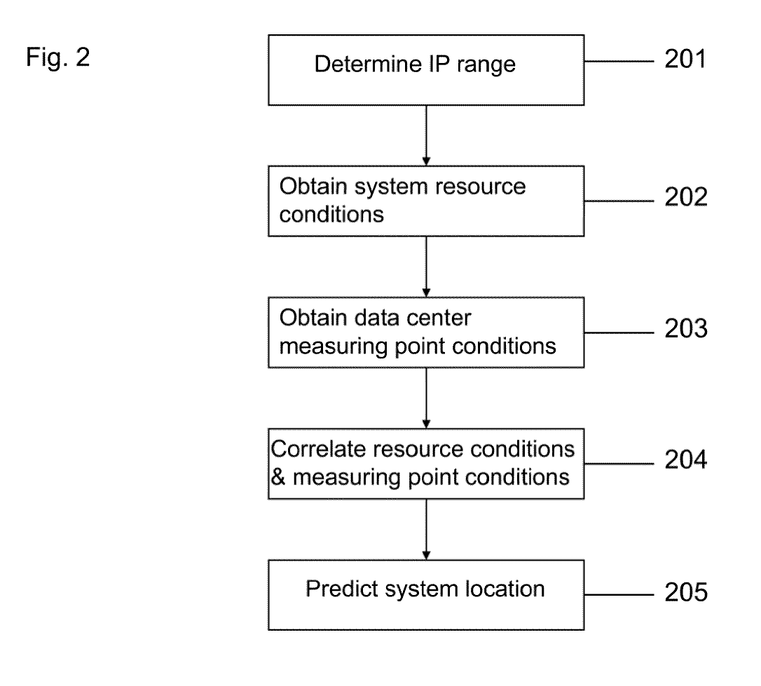

FIG. 2 is a depiction of one embodiment of the invention that utilizes the correlation between measuring points and system resources to predict the location of systems in the data center. Specifically, this embodiment of the invention deals with a method to predict the location of a system in a data center.

First, as depicted in step 201, an IP range is determined, to look for all of the systems available on that IP range. Each system in the data center has an IP address associated with it. Only those systems with IP addresses that fall within the IP range chosen will be utilized in location prediction. The range can be narrow, or can encompass a large number of the systems, or even all of the systems in the data center. Choosing an IP range enables the location of specific machines. For example, in the event of a power crisis or overheating of a certain group of systems, the IP range can be determined to only encompass those affected systems.

Once the IP range has been determined, measurements from measuring points in the data center will be obtained, at step 202. The measuring points that are utilized depend upon the infrastructure of the data center. Those measuring points already existing in the data center are preferably utilized for obtaining measurements, although it is possible to place additional measuring points into a data center for the purposes of the invention. At the same time, measurements from the resources in the system will be obtained, at step 203. For example, such measurements could comprise temperature measurements, power consumption measurements, and network bandwidth measurements, to name a few.

Step 204 details correlating the values obtained from steps 202 and 203. These values are correlated and the correlation coefficients for the values from each system condition and the values obtained from the measuring points are obtained. Then, in one embodiment, a profile table is created for each system condition. This profile table is populated with all of the correlation coefficients between the measuring points and the system resources. Preferably, the table can hold information regarding a specific system condition (such as power, temperature, etc.) for a system and the corresponding measuring points. Thus, a plurality of tables could be created as necessary to correlate system conditions with measurements obtained from the measuring points. This enables faster processing of the correlation, without requiring that unnecessary information is stored in the system. In another embodiment, the table can also be configured to hold information for each system condition for a system and the corresponding measuring points. This would enable a quick lookup for a correlation of the system conditions for a system and the corresponding measuring points.

Step 205 details predicting a location of a system. The correlation values obtained from the correlating step 204 have been stored in one or more profile tables, and associations are available between systems and a measuring point or measuring points. A correlation value is a number from −1 to 1. A correlation of 1 between two variables means that as the value of one variable changes, the value of another changes in exact proportion. A correlation of −1 between two values indicates that as the value of one variable changes, the value of the second variable changes in exact proportion in an opposite way. A correlation of 0 between two variables indicates that as the first variable changes, no corresponding change can be found in the second change. Thus, the behavior of the first variable has no effect or relationship with the behavior of the second variable. The method maintains a counter of a system's location based upon a measuring point or measuring points, and provides an accuracy percent of the location based upon the associations stored in the profile table(s). This counter could be in the form of a register. In another embodiment, a location table could be utilized to maintain a system location based upon a measuring point or measuring points.

In one embodiment, the method is continually running, and the system resources and the measuring points are continually monitored. This enables constant updating of the correlations between the system and the measuring point or measuring points, and enables the accuracy of the associations between a system and the measuring point or measuring points to be increased. More information is detailed below regarding accuracy of the associations between systems and measuring points. A specific system may never be associated with a single measuring point; rather, it may oscillate in its correlations between two or more measuring points. Still, based upon the associations between the system and the one or more measuring points, the system can be correlated with a reference location based upon its association with the one or more measuring points.

The accuracy of the reference location obtained from the location prediction of the invention depends upon the amount of data used in the correlation of measuring points and system resources, as well as the amount of time the systems and measuring points are monitored. The location prediction method may be able to exactly determine the location of the system in the data center, or may be able to predict the system is on a specific rack or on one of a specific number of racks in the data center, and so forth. The more measuring points and data resources that are utilized in location prediction will likely yield more specific results concerning the location of the system in the data center. Similarly, monitoring the measuring points and systems for a longer period of time will likely yield more specific results concerning the location of the system.

By repeatedly monitoring the systems and the measuring points in the data center, location prediction can be iteratively carried out, enabling the location of the systems in the data center to be maintained and updated. Iteratively locating the systems utilizing the location prediction system also enables an association of measuring points with specific systems or groups of systems. The locations of the measuring points in the data center are known and constant. If a system maintains its location, with each location prediction, a pattern will emerge such that the system is consistently found to be near specific measuring points. Thus, an association of the locations of the measuring points with respect to the systems in the data center can be made. Further, re-calculating the correlations based upon each iterative performance of location prediction increases the accuracy of the associations of the measuring points with the systems. The association may be a one-to-one association, or may associate a plurality of systems with one or more measuring points, or a plurality of measuring points with one or more systems.

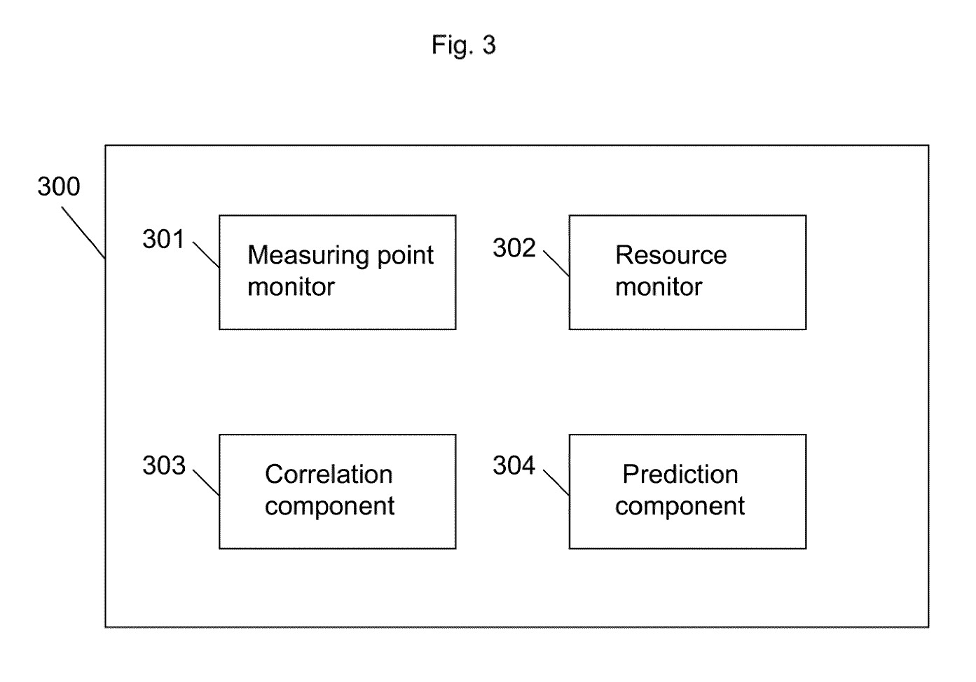

FIG. 3 is a depiction of another embodiment of the invention that utilizes the correlation between measuring points and system resources to predict a location of systems in the data center. Specifically, this embodiment of the invention comprises an apparatus that is utilized to predict the location of a system in a data center. The apparatus contains a measuring point monitor 301, a resource monitor 302, a correlation component 303 and a prediction component 304.

The measuring point monitor 301 monitors the measuring points in the data center. The measuring points that are utilized depend upon the infrastructure of the data center. Those measuring points already existing in the data center are preferably utilized for obtaining measurements, although it is possible to place additional measuring points into a data center for the purposes of the invention.

The system monitor 302 monitors system resources in the data center. An IP range may be determined to potentially limit the number of systems in the data center that are monitored. Each system in the data center has an IP address associated with it. Only those systems with IP addresses that fall within the IP range chosen will be utilized in location prediction. As explained above, the IP range can be narrow, or can encompass a large number of the systems, or even all of the systems in the data center. Choosing an IP range enables the location of specific machines. For example, in the event of a power crisis or a heavy workload directed towards a certain group of systems, the IP range can be determined to only encompass those affected systems.

The correlation component 303 correlates the values obtained from the measuring point monitor 301 and the system monitor 302. These values are correlated and the correlation coefficients for the values from each system condition and the values obtained from the measuring points are obtained. In one embodiment, a profile table is created for each system condition. This profile table is populated with all of the correlation coefficients between the measuring points and the system resources. In one embodiment, the table can hold information regarding a specific system condition (such as power, temperature, etc.) for a system and the corresponding measuring points. Thus, a plurality of tables could be created as necessary to correlate system conditions with measurements obtained from the measuring points. This enables faster processing of the correlation, without requiring that unnecessary information is stored in the system. In another embodiment, the table can also be configured to hold information for each system condition for a system and the corresponding measuring points. This would enable a quick lookup for a correlation of the system conditions for a system and the corresponding measuring points.

The prediction component 304 then predicts the location of a system. The correlation values obtained from the correlating component 303 have been stored, and associations are available between systems and a measuring point or measuring points. In one embodiment, the apparatus maintains a counter of a system's location based upon a measuring point or measuring points, and provides an accuracy percent of the location based upon the associations stored in the profile table(s). In another embodiment, a location table is utilized to hold information regarding each system and its location based upon a measuring point or measuring points. Preferably, the apparatus is continually running the system monitor and the measuring point monitor, and the system resources and the measuring points are continually monitored. This enables constant update of the correlations between the system and the a measuring point or measuring points, and enables the accuracy of the associations between a system and a measuring point or measuring points to be increased. A specific system that is monitored in the data center may never be associated with a single measuring point; rather, it may oscillate in its correlations between two or more measuring points. Still, based upon the associations between the system and the one or more measuring points, the system can be correlated with a reference location based upon its association with one or more measuring points.

In one embodiment, a computer readable medium may have encoded thereon computer readable code which when executed, performs a method as depicted in FIG. 2 to predict the location of a system in a data center.

In one embodiment, a correlation between a condition measured from a system resource X and a measuring point Y is determined utilizing the following correlation coefficient equation:

$$Corr ( X , Y ) = \frac{\sum ( x - \overline{x} ) \sum ( y - \overline{y} )}{\sum {( x - \overline{x} )}^{2} \sum {( y - \overline{y} )}^{2}}$$

This correlation coefficient equation is a standard correlation coefficient equation. Other equations may also be utilized for correlating the measurements obtained from the system resources and the measuring points.

In one embodiment, correlations are made according to system conditions. Thus, correlations are only made for measuring point values and system resource values that correspond to the same type of measurement. For example, values from an internal temperature sensor in a system and a heat sensor on a rack in the data center would be correlated.

In another embodiment, location prediction takes into account the time at which each measurement was obtained. Timing is also utilized in the correlation, so that measurements obtained at the same time from the different sources are correlated together. This enables a more accurate representation of the effect of changes in the systems on the measurements obtained from the measuring points.

In one embodiment, prediction of the location of a system is forced in a shortened period of time. This forced prediction may be utilized because a system affected by a power management issue or hardware failure may need to be located quickly. Various other reasons exist for forcing a prediction of a location of a specific system. In one implementation of the forced location prediction, the system is perturbed to trigger some effect that is measured by both internal system resources and which has an effect on the data center measuring points. An example of a perturbation would be to have the system running at full utilization for a specific period of time. This would increase the heat of the system and the potential bandwidth usage of the system, which would be noted by heat sensors and bandwidth measurers in the system.

At the time the system was perturbed, the monitoring of the measuring points and system resources would be activated. A measuring point in the data center that measured bandwidth for a group of systems that included the perturbed system may note increased bandwidth usage. Further, measuring points such as temperature sensors or air conditioners may note increased activity due to a larger dissipation of heat coming from a particular group of systems that include the perturbed system. Correlation of the measurement values obtained from the measuring points of the data center, and the measurement values obtained from the internal system resources may be utilized to predict the location of the system with respect to specific measuring points.

In another embodiment utilizing the forced location prediction, a system is perturbed as described above, for a limited period of time. Based upon the previous correlation data obtained by running the system under normal conditions, specific measuring points are monitored that are already associated with the system. The data obtained from those measuring points in relation to the perturbation of the system is then utilized to calculate new correlation coefficients for the selected measuring points and the system. Thus, more accurate associations for the system and corresponding measure points can be potentially obtained.

In one embodiment, location prediction obtains values from the measuring points utilizing the Dynamic Smart Cooling Energy Manager solution, which provides historical information regarding environmental and thermal information of the measuring points for location prediction.

In one embodiment, location prediction obtains values from the system resources through the use of standard SNMP agents that are configured in each system. Thus, each system provides its information through these agents for location prediction, without external prompting. This enables continual monitoring of the resources of the system without outside intervention.

In another embodiment, the systems are polled to obtain information about the status of their resources. In this embodiment, the systems are polled and data from the resources are gathered. This data is then stored in a database, such as an MSQL database, for later use. The type of database in which the gathered data is stored is not limiting; rather, any type of database could be utilized.

In another embodiment, the system is not continually monitored. By continually monitoring the system, correlations and predictions regarding system location are made even if there are no changes in the status of the system resources. These correlations enable more accurate prediction of the location of the system. However, continually monitoring the system when the status of the resources of the system does not change may potentially be inefficient and could cause network congestion issues, as system monitors continually obtain information from the systems in the data center.

Thus, this embodiment of the invention utilizes a subscriber-based system, in which a script is run on a system to subscribe to get information regarding a specific condition, such as power utilization, on a system. When the condition changes (for example a value of at least one resource of the system changes), such as an increase in power utilization, the system notifies the location prediction system, and an updated correlation is conducted to predict the location of the system. In one embodiment, Web-Based Enterprise Management (WBEM) could be utilized as the subscription method for the systems. Thus, location prediction is only performed when a notification is received that one or more system conditions in a system are changing.

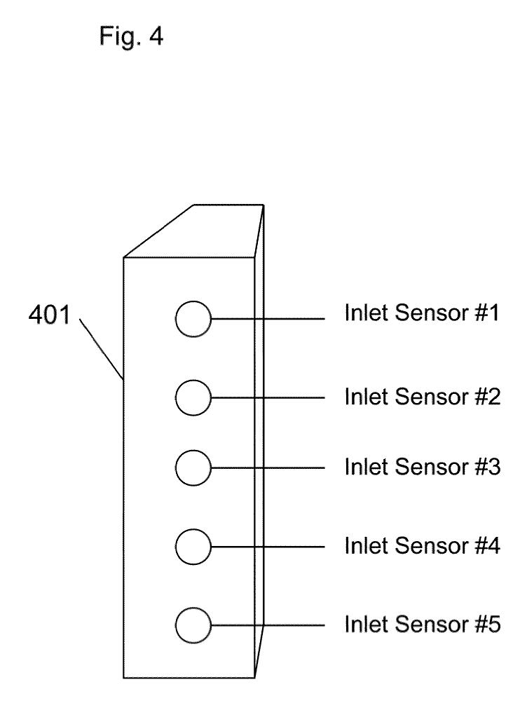

In another embodiment, a data center is populated with a plurality of racks, with one specific rack including five temperature sensors located at the back of the rack. For example, the data center may contain 7 racks (racks #1-7) with heterogeneous configuration. Each rack contains 10 temperature sensors that distributed between the back and front of the rack. FIG. 4 depicts an exemplary rack 401 in the data center, with inlet and outlet sensors #1-5. Only the inlet sensors are depicted in FIG. 4. Often, data center equipment receives cold air from the front and releases hot air from the back. Thus, preferably, correlation is done by analyzing the sensors placed on the back of data center equipment. Location prediction is carried out in this exemplary data center, with the following results.

Location prediction is continually performed, and then a system is selected from the rack for analysis. Specifically, a system is chosen on Rack #1, near the inlet and outlet sensors #4. This selected system could, for example, be a BL20P blade system that runs Windows. The type of system is not limiting, and could be any system. The conditions of the resources of the selected system were obtained by utilizing Proliant software to gather SNMP information and internal CPU information from the system. However, the software utilized is not limiting on the invention.

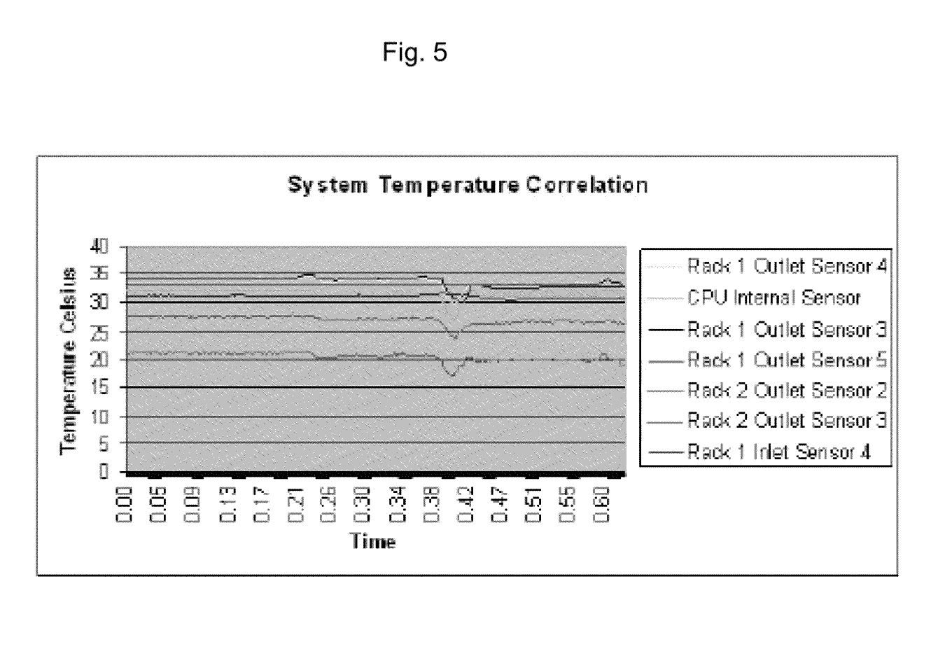

In this embodiment, the system is monitored for 15 hours. At hour 9, an outside perturbation occurs that affects the system. FIG. 5 depicts a thermal response from measuring points in the data center with best correlations to the associated system resources indicating internal CPU temperature. FIG. 5 only shows the sensors which have a correlation greater than an acceptable threshold. For example, the threshold could be 0.75. This threshold is variable, and can be pre-set, or set by an outside source, or set on the fly.

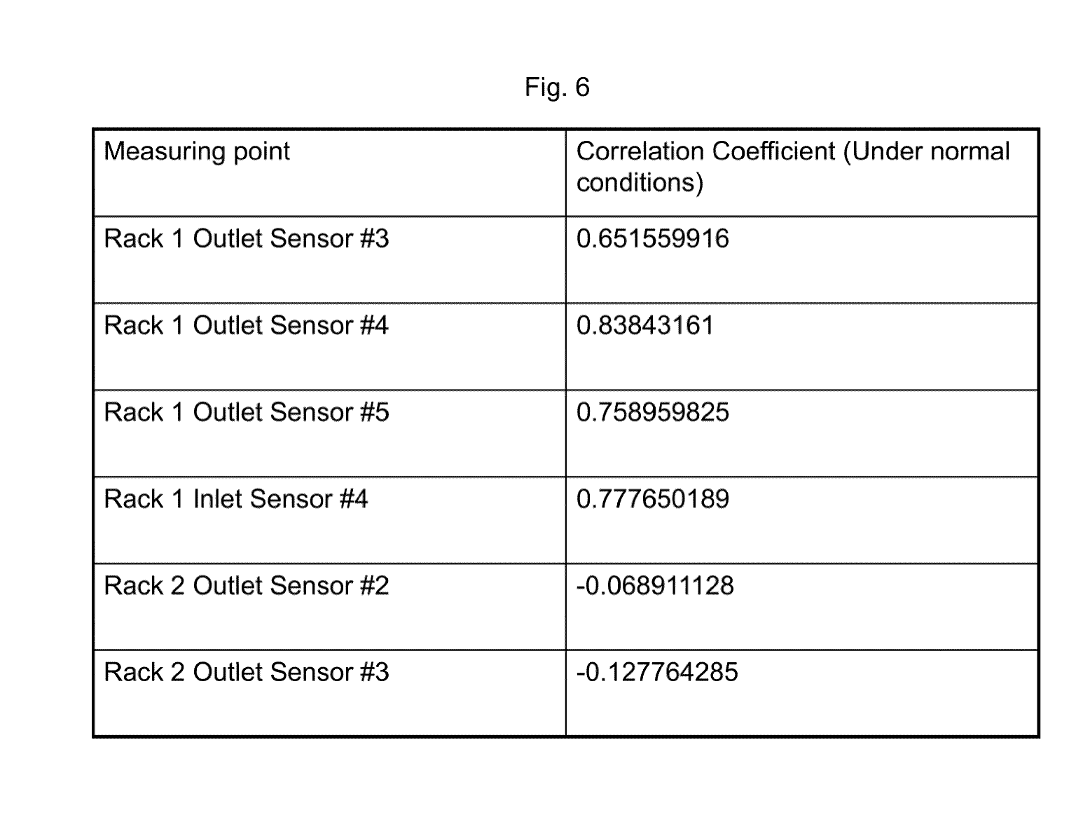

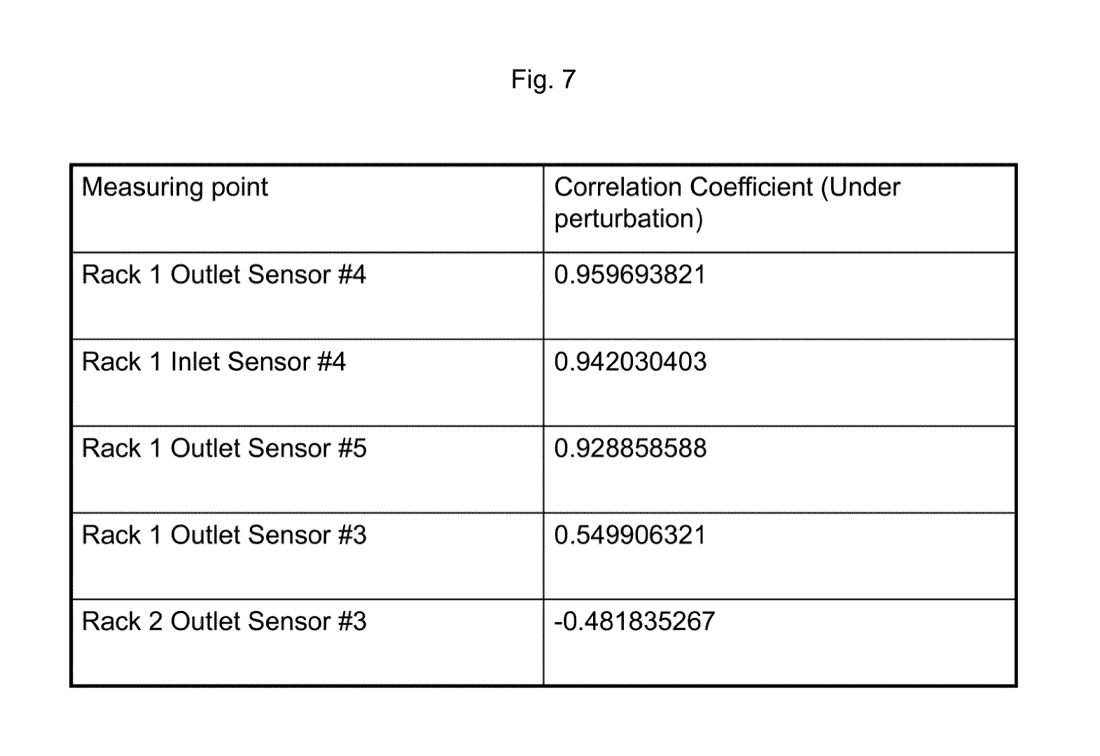

Correlation coefficients are calculated between all the measuring points (the ten sensors on the rack) and the system internal temperature. FIG. 6 shows a table containing the correlation coefficients utilizing only data obtained under normal circumstances, without taking into account the system perturbation. FIG. 7 shows a table containing correlation coefficients that take into account the system perturbation. Both correlations yield the correct location for the system (i.e. near inlet and outlet sensors #4), with FIG. 7 yielding a more accurate result.

With regards to utilizing location prediction for a BL20P system, as mentioned above, it is important to take note that this system has two CPUs, and three internal sensors. Each CPU core has a sensor, and there is one sensor located in the system that is outside the core module. The sensor outside the core module is preferably utilized for monitoring, since the internal sensors are typically very sensitive to system utilization and tend to be hot. Further, one core sensor may be hot, while another is cooler, providing mixed data that may not lend itself well to correlation. Further, utilizing an internal sensor from each of the systems, that is not dependent upon the number of CPUs may be more easily scalable and provide more accurate results because the values being compared from each of the systems will be obtained from more similar system environments.

An exemplary system for implementing the overall system or method or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. An apparatus for predicting a location of a system in a data center, comprising:
a measuring point monitor for obtaining values from one or more measuring points in a data center;
a system monitor for obtaining values from one or more resources of the system;
a correlation component for correlating the values from the measuring point monitor with the values from the system monitor;
a prediction component for predicting the location of the system in the data center based upon the correlation.

2. The apparatus of claim 1,
wherein the measuring point monitor automatically obtains measuring point values and the system monitor automatically obtains resource values, and
wherein location of the system is updated periodically based upon these continually obtained values.

3. The apparatus of claim 1, further comprising a perturbation component, the perturbation component comprising:
a trigger for triggering a system in the data center such that the resources of the system are affected;
a system activator for activating the system monitor to measure the effects on the resources of the system;
a measuring point activator for activating the measuring point monitor to monitor the measuring points of the data center;
a perturbation value submitter for submitting the values obtained from the system monitor and measuring point monitor to the correlation component;
wherein the prediction component predicts the location of the system based upon the correlation from the correlation component.

4. The apparatus of claim 1, further comprising a subscription component that tracks systems that have subscribed to a notification service,
wherein the notification service obtains a notification when at least one value from a resource in a subscribed system has changed,
wherein, when a notification is received, the measuring point monitor obtains values from the measuring points in the data center and the system monitor obtains values from the subscribed system's resources, to be used for predicting the location of the subscribed system.

5. The apparatus of claim 1, further comprising an IP range setting component for setting an IP range of systems,
wherein the system monitor only obtains resource values from systems that fall within the IP range.

6. The apparatus of claim 1, wherein the correlation component utilizes the times at which values were obtained from the system resources and the measuring points to correlate the values from the measuring point monitor and the system monitor.

7. The apparatus of claim 1, wherein the correlation component correlates each of the values obtained from the measuring point monitor with values obtained from the system monitor that correspond to the same type of measurement.

8. A method to predict a location of a system in a data center, comprising:
(a) monitoring at least one measuring point in said data center;
(b) monitoring at least one resource of the system;
(c) correlating the values of the at least one measuring point with the values of the at least one system resource; and
(d) predicting the location of the system in said data center based upon the correlation.

9. The method of claim 8, further comprising:
(e) iteratively repeating steps (a) to (d).

10. The method of claim 8, further comprising:
(e) triggering a system in the data center such that the resources of the system are affected;
(f) activating the system monitor to measure the effects on the resources of the system;
(g) activating the measuring point monitor to monitor the measuring points of the data center;
(h) submitting the values obtained from the system monitor and measuring point monitor to the correlation step (c);
(i) predicting the location of the system based upon the correlation from the correlation obtained in step (h).

11. The method of claim 8, further comprising:
(e) tracking systems that have subscribed to a notification service;
(f) obtaining a notification when at least one value from a resource in a subscribed system has changed,
wherein receiving a notification prompts the method to carry out steps (a) to (d) to predict the location of the subscribed system.

12. The method of claim 8, further comprising:
(e) setting an IP range of systems,
wherein only systems that have IP addresses with the IP range that is set have their resource values monitored.

13. The method of claim 8, wherein correlating the values further comprises utilizing the times at which values were obtained from the system resources and the measuring points to correlate the values from the measuring points and the system resources.

14. The method of claim 8, wherein correlating the values further comprises correlating each of the values obtained from the at least one measuring point with values obtained from the at least one system resource that correspond to the same type of measurement.

15. A computer readable medium, having installed thereon computer readable code which when executed, performs a method to predict a location of a system in a data center, comprising:
(a) monitoring at least one measuring point in said data center;
(b) monitoring at least one resource of the system;
(c) correlating the values of the at least one measuring point with the values of the at least one system resource; and
(d) predicting the location of the system in said data center based upon the correlation.

16. The computer readable medium of claim 15, further comprising:
(e) iteratively repeating steps (a) to (d).

17. The computer readable medium of claim 15, further comprising:
(e) triggering a system in the data center such that the resources of the system are affected;
(t) activating the system monitor to measure the effects on the resources of the system;
(g) activating the measuring point monitor to monitor the measuring points of the data center
(h) submitting the values obtained from the system monitor and measuring point monitor to the correlation step (c);
(i) predicting the location of the system based upon the correlation from the correlation obtained in step (h).

18. The computer readable medium of claim 15, further comprising:
(e) tracking systems that have subscribed to a notification service;
(f) obtaining a notification when at least one value from a resource in a subscribed system has changed,
wherein receiving a notification prompts the method to carry out steps (a) to (d) to predict the location of the subscribed system.

19. The computer readable medium of claim 15, wherein correlating the values further comprises utilizing the times at which values were obtained from the system resources and the measuring points to correlate the values from the measuring points and the system resources.

20. An apparatus for predicting the location of a system in a data center, comprising:
means for obtaining values from one or more measuring points in a data center;
means for obtaining values from one or more resources of the system;
means for correlating the values from the measuring point monitor with the values from the system monitor;
means for predicting the location of the system in the data center based upon the correlation.
